(19) United States
(12) Patent Application Publication
(10) Pub. No.: US 2007/0133222 A1
(43) Pub. Date: Jun. 14, 2007

(54) Liquid crystal display device and backlight device

(76) Inventors: Saburo Watanabe, Ichinomiya (JP); Hiroshi Tokuyama, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/637,094

(22) Filed: Dec. 12, 2006

(30) Foreign Application Priority Data
Dec. 12, 2005 (JP) 2005-357116

(51) Int. Cl. F21V 7/04

(52) U.S. Cl. 362/561

(57) ABSTRACT

The present invention provides a liquid crystal display device having a backlight device which can fix an LED light source at an optimum position with respect to a light guide plate and also can effectively radiate heat. In a liquid crystal display device which includes a liquid crystal panel and a backlight device, the backlight device includes a light guide plate, a printed circuit board which mounts a LED light source which is arranged to face a side surface of the light guide plate thereon and forms a leg portion thereon, and a metal-made lower frame member which is positioned on a surface of the printed circuit board opposite to a side on which a leg portion of the printed circuit board and the LED light source are mounted, wherein the printed circuit board is a board which adopts a metal member as a base, the lower frame member includes a hole portion into which a leg portion of the printed circuit board is inserted, and the printed circuit board has the leg portion thereof inserted into the hole portion of the lower frame member, and has a surface thereof on a side opposite to a side on which the LED light source is mounted fixed to the lower frame member by a pressure sensitive adhesive double-coated tape.

### CROSS-REFERENCE TO RELATED APPLICATIONS

The disclosure of Japanese Patent Application No. 2005-357116 filed on Dec. 12, 2005 including the specification, drawings and abstract is incorporated herein by reference in its entirety.

### BACKGROUND

1. Field of the Invention

The present invention relates to a liquid crystal display device having a backlight device, and more particularly to the fixing structure or the heat radiation structure of a spot light source of a backlight device which includes a spot light source such as an LED.

2. Description of Related Arts

Recently, as a backlight device which is arranged on a back surface of a transmissive liquid crystal display panel, there has been used a side light type backlight device which arranges a spot light source such as an LED on a side surface of a light guide plate. The side light type backlight device arranges the LED light source which is mounted on a flexible substrate on the side surface of the light guide plate. Here, with respect to the manner of fixing the flexible substrate on which the LED light source is mounted, as described in patent document 1 (Japanese Patent Laid-Open No. 2003-279973), fixing and positioning of the flexible substrate is performed by arranging a projecting portion smaller than the LED light source on an end portion of a printed circuit board which mounts the LED thereon, by arranging a guide projection having a width larger than a width of the LED light source on a center portion of the printed circuit board, and by further arranging mounting grooves and guide grooves on a frame body side.

### SUMMARY

When a board which mounts an LED light source thereon is formed of a flexible printed circuit board, besides the positioning of the flexible printed circuit board, the manner of radiating heat generated by the LED light source is a crucial task.

It is an object of the present invention to provide a liquid crystal display device which uses a side-light-type backlight device which adopts an LED as a light source, wherein the LED can be fixed to an optimum position with respect to a light guide plate, and the backlight device is configured to further efficiently perform the heat radiation.

According to a first aspect of the present invention, there is provided a liquid crystal display device which includes a liquid crystal panel and a backlight device arranged on a back surface of the liquid crystal panel, wherein the backlight device includes a light guide plate, a printed circuit board which mounts an LED light source which is arranged to face a side surface of the light guide plate thereon and has a leg portion, and a metal-made lower frame member which is positioned on a surface of the printed circuit board opposite to a side on which a leg portion of the printed circuit board and the LED light source are mounted, wherein the printed circuit board is a board which adopts a metal member as a base, the lower frame member includes a hole portion into which a leg portion of the printed circuit board is inserted, and the printed circuit board has the leg portion thereof inserted into the hole portion of the lower frame member, and has a surface thereof on a side opposite to a side on which the LED light source is mounted fixed to the lower frame member by a pressure sensitive adhesive double-coated tape.

Due to such a constitution, the printed circuit board on which the LED light source is mounted is guided to the accurate position on the lower frame member and, further, it is possible to efficiently perform the radiation of heat of the LED light source. Compared to a case in which the board and the lower frame member are fixed to each other using an adhesive agent, the pressure sensitive adhesive double-coated tape does not require a large curing time (approximately 24 hours until the adhesive agent is cured) which the adhesive agent requires thus remarkably facilitating the operability.

Here, when the board is fixed using only the pressure sensitive adhesive double-coated tape without forming the leg portion on the printed circuit board different from the present invention, there exists a possibility that the pressure sensitive adhesive double-coated tape is peeled off due to a change of an adhesive force and the thermal expansion attributed to a temperature change. Accordingly, as a means to cope with such a drawback, as in the case of the present invention, the constitution which inserts the leg portion of the printed circuit board into the hole portion which is formed in the frame member thus suppressing the warping of the pressure sensitive adhesive double-coated tape in the peeling-off direction and fixing the printed circuit board and the lower frame member is extremely effective.

Further, means which prevents an upper portion of the printed circuit board from falling down to the light guide plate side by applying the drawing to an upper side of the printed circuit board opposite to the side on which the leg portion of the printed circuit board is formed (for forming projections or the like on the frame) is also extremely effective.

According to another aspect of the present invention, there is provided a liquid crystal display device which includes a liquid crystal panel and a backlight device which is arranged on a back surface of the liquid crystal panel, wherein the backlight device includes a light guide plate, a printed circuit board which mounts two or more LED light sources which are arranged in the direction toward a side surface of the light guide plate thereon and includes 2 or more and 5 or less leg portions having a width of 0.7 mm or more and 30.0 mm or less, and a metal-made lower frame member which is integrally formed at a position which faces a side of the printed circuit board opposite to a side on which a leg portion of the printed circuit board and the LED light source are mounted, the printed circuit board is a board which adopts a metal member as a base, the lower frame member includes a hole portion corresponding to a position of the leg portion formed on the printed circuit board, and the printed circuit board has the leg portion thereof inserted into the hole portion of the lower frame member and has a surface of the printed circuit board on a side opposite to a side on which the LED light source is mounted fixed to the lower frame member by a pressure sensitive adhesive double-coated tape.

Due to such a constitution, it is possible to obtain the substantially same advantageous effects as the above-mentioned invention.

According to another aspect of the present invention, there is provided a backlight device which includes a light guide plate, a printed circuit board which mounts an LED light source which is arranged to face a side surface of the light guide plate thereon and has a leg portion, and a metal-made lower frame member which is positioned on a surface of the printed circuit board opposite to a side on which a leg portion of the printed circuit board and the LED light source are mounted, wherein the printed circuit board is a board which adopts a metal member as a base, the lower frame member includes a hole portion into which a leg portion of the printed circuit board is inserted, and the printed circuit board has the leg portion thereof inserted into the hole portion of the lower frame member, and has a surface thereof on a side opposite to a side on which the LED light source is mounted fixed to the lower frame member by a pressure sensitive adhesive double-coated tape.

Due to such a constitution, it is possible to obtain the substantially equal advantageous effects as the above-mentioned invention.

According to the present invention, it is possible to provide the liquid crystal display device having a backlight device which is configured to fix the LED light source at an optimum position with respect to a light guide plat thus further efficiently radiating the heat.

### BRIEF DESCRIPTION OF THE DRAWINGS

FIG. 1 is a view showing the whole constitution of a liquid crystal display device according to the present invention;

FIG. 2 is a side view of a printed circuit board as viewed from a side directed to a light guide plate;

FIG. 3 is a structural view showing a backlight device in an actually assembled state;

FIG. 4 is a cross-sectional view taken along a line a-a′ in FIG. 3;

FIG. 5 is an enlarged view of a characterizing part of the present invention in FIG. 4;

FIG. 6 is a view showing the transfer of heat in a lower frame of the present invention;

FIG. 7 is an explanatory view with respect to a width and the number of leg portions which are formed on a printed circuit board of the present invention; and

FIG. 8 is a view showing the cross-sectional structure of the printed circuit board of the present invention.

### DETAILED DESCRIPTION OF THE INVENTION

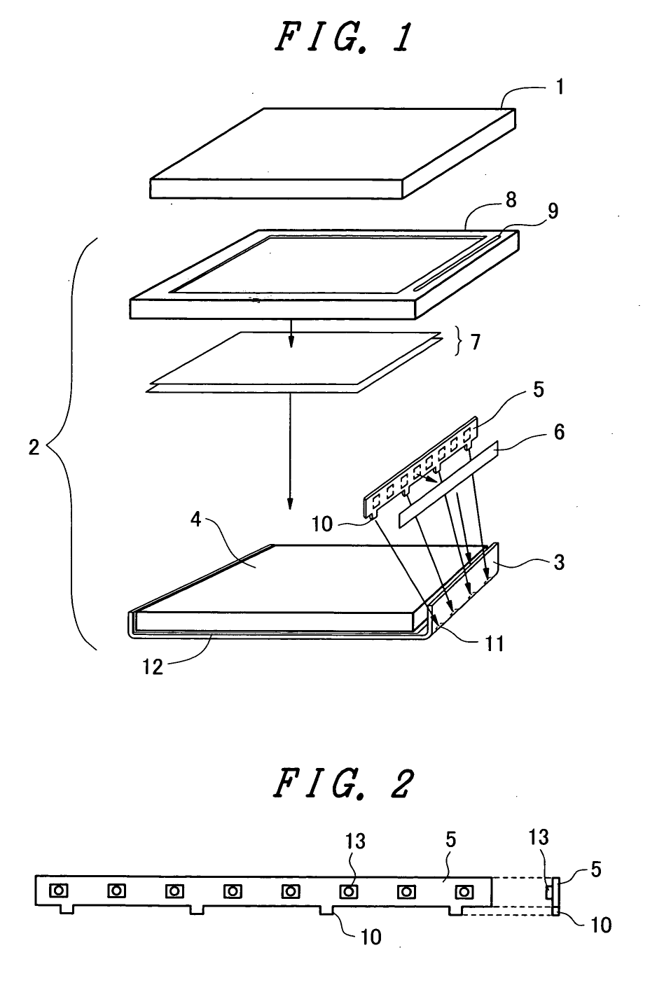

FIG. 1 is a view showing the whole structure of a liquid crystal display device according to the present invention. As shown in FIG. 1, the liquid crystal display device of the present invention is constituted of a liquid crystal panel 1 and a backlight device 2. Here, although a liquid-crystal-panel holding frame which holds the liquid crystal panel 1 is arranged in the actual liquid crystal display device, since the holding frame is not relevant to a characterizing part of the present invention, the holding frame is omitted.

The backlight device 2 is constituted of, in the present invention, a lower frame 3 which is made of metal such as aluminum, stainless steel or steel, a light guide plate 4 which is arranged to be held by the lower frame 3, a printed circuit board 5 which mounts LED light sources which are arranged toward one side surface of the light guide plate 4, has a leg portion and forms a base thereof with metal such as aluminum, copper or steel, a pressure sensitive adhesive double-coated tape which fixes a surface of the printed circuit board 5 on a side opposite to the side on which the LED light sources are mounted and the lower frame, optical sheets 7 such as a prism sheet, a diffusion sheet and the like which are arranged above the light guide plate 4, and an upper frame 8. Here, a reflective sheet 12 is arranged between the lower frame 3 and the light guide plate 4.

A peripheral arrangement of the printed circuit board 5 which constitutes the characterizing part of the present invention is explained in further detail in conjunction with FIG. 2 to FIG. 5.

FIG. 2 is a side view of the printed circuit board 5 as viewed from a side directed to the light guide plate 4.

A plurality of packaged LED light sources 13 is fixed to the printed circuit board 5 by soldering, and the leg portion 10 is formed on a lower side of the printed circuit board 5. By inserting the leg portion 10 into a hole portion 11 formed in the lower frame described later, it is possible to accurately position the printed circuit board 5 at a desired position.

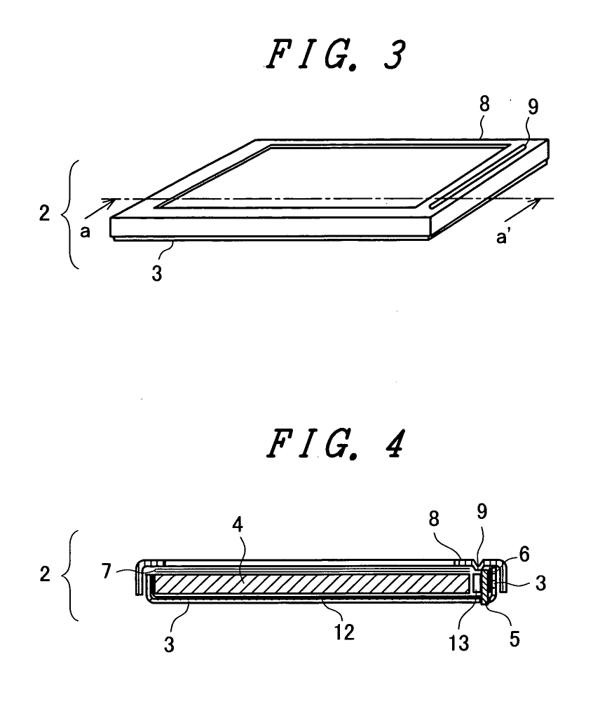

FIG. 3 is a structural view showing the backlight device 2 in an actually assembled state. As shown in FIG. 3, the backlight device 2 is configured such that the lower frame 3 is covered with the upper frame 8.

FIG. 4 is a cross-sectional view taken along a line a-a′ in FIG. 3. In the backlight device 2 of the present invention, respective members are held in a state shown in FIG. 4 which is the cross-sectional view, wherein the joining relationship of the printed circuit board 5 with the members such as the lower frame 3, an upper frame 8 and the like in the periphery of the printed circuit board 5 constitutes the characterizing part of the present invention.

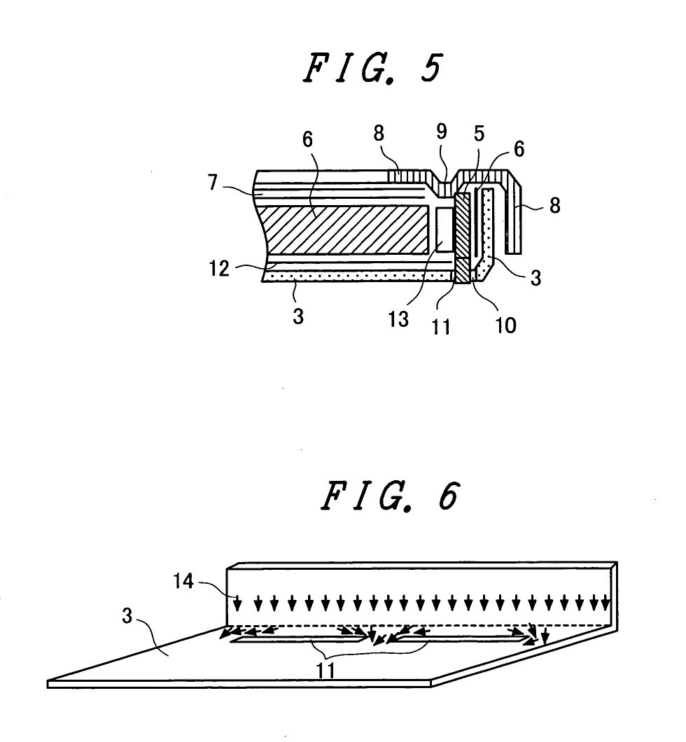

FIG. 5 is an enlarged view of a characterizing part of the present invention in FIG. 4. As shown in FIG. 5, the positioning of the printed circuit board 5 is performed by inserting the leg portion 10 formed on the printed circuit board 5 into the hole portion 11 which is formed in the lower frame 3 and, further, the printed circuit board 5 is fixed to the lower frame 3 by laminating the thermally-conductive pressure-sensitive-adhesive-double-coated tape 6 to a surface thereof on a side of the printed circuit board 5 opposite to the side on which the LED light sources 13 are mounted.

According to the present invention, it is possible to obtain an advantageous effect that the printed circuit board 5 can be fixed using only the usual pressure sensitive adhesive double-coated tape. However, by adopting the thermally conductive (thermal conductivity: 0.2 W/m·k or more) pressure sensitive adhesive double-coated tape as the pressure sensitive adhesive double-coated tape, it is possible to expect a further advantageous effect that heat generated from the LED light sources 13 can be efficiently radiated. Here, the thermal conductivity of the usual pressure sensitive adhesive double-coated tape is approximately 0.09 W/m·k to 0.16 W/m·k and hence, such a tape exhibits a favorable thermal conductivity compared to the thermal conductivity of 0.026 W/m·k of air. Accordingly, although the heat radiation effect may be obtained using the usual pressure sensitive adhesive double-coated tape, with the use of the pressure sensitive adhesive double-coated tape having the further higher heat conductivity, it is possible to expect a further heat radiation effect. That is, according to the present invention, it is found out to be effective to use the pressure sensitive adhesive double-coated tape having the heat conductivity of 0.2 W/m·k or more. Further, with the use of the pressure sensitive adhesive double-coated tape having the heat conductivity of 0.4 W/m·k or more, the advantageous effect can be further enhanced. Still further, with the use of the pressure sensitive adhesive double-coated tape having the heat conductivity of 0.5 W/m·k or more, the advantageous effect can be still further enhanced.

To further strengthen the fixing of the printed circuit board 5, a projecting portion 9 is formed on the upper frame 8 such that the printed circuit board 5 is sandwiched by the projecting portion 9 and the lower frame 3. Due to such a constitution, it is possible to prevent the printed circuit board 5 from falling down to the light guide plate 4 side.

Next, the relationship of a width and the number of the leg portions 10 formed on the printed circuit board 5 of the present invention is explained.

Heat generated by the LED light sources 13 is transferred to the lower frame 3 by way of the printed circuit board 5 and thermally conductive pressure sensitive adhesive double-coated tape 6, and the transferred heat is diffused in the whole lower frame 3 and hence, the lower frame 3 is cooled due to the heat radiation of an air layer and a convection of air.

Here, although the hole portion 11 into which the leg portion 10 of the printed circuit board 5 is inserted is formed in the lower frame 3, there is no diffusion of heat in the portion where the hole portion 11 is formed. Accordingly, when the large hole is formed, the heat radiation performance of the lower frame 3 is lowered. That is, when a large groove described in patent document 1 is formed, although the mounting and the fixing of the printed circuit board 5 to the lower frame 3 is facilitated, there arises a drawback that the heat cannot be radiated efficiently.

The relationship between the hole portion 11 formed in the lower frame 3 and the heat radiation is explained in conjunction with FIG. 6.

Arrows shown in FIG. 6 indicate heat radiated from an LED light sources 13. That is, the arrows shown in FIG. 6 indicate a state in which the heat radiated from the LED light sources 13 is transmitted to the lower frame 3 by way of the printed circuit board 5 and the thermally conductive pressure sensitive adhesive double-coated tape 6.

Although the heat is transferred and diffused through the lower frame 3 made of metal as shown in the arrows, when the hole portion 11 shown in FIG. 6 is largely formed, the transfer of heat is interrupted by the hole portion 11 and hence, the heat is not efficiently diffused over the whole surface of the lower frame 3 whereby it is impossible to achieve the sufficient heat radiation eventually.

Accordingly, in the present invention, inventors of the present invention have found out that the efficient heat radiation cannot be achieved unless the desired relationship is satisfied between the leg portion 10 formed on the printed circuit board 5 and the hole portion 11 formed in the lower frame 3 attributed to the leg portion 10. Based on such finding, the inventors have acquired the predetermined relationship with respect to the relationship among the width of the leg portion 10 of the printed circuit board 5, an interval of the LED light sources 13 and a plate thickness of the printed circuit board as the constitution for acquiring the heat radiation effect.

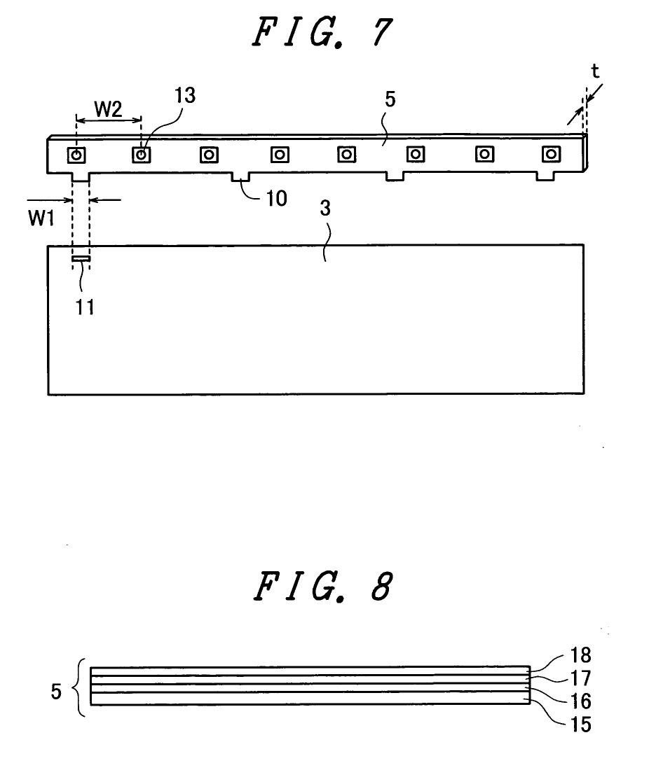

This constitutional feature is explained in conjunction with FIG. 7.

FIG. 7 shows a case in which a plate thickness of the printed circuit board 5 is set tot, the width of the leg portion of the printed circuit board 5 is set to W1, and the interval of the LED light sources 13 which are mounted on the printed circuit board 5 is set to W2. In FIG. 7, only one hole portion 11 formed in the lower frame 3 is indicated and other hole portions and the constitution thereof are omitted.

According to the present invention, in adopting the relationship indicated in FIG. 7, by setting the width W1 to a value which is equal to or more than the plate thickness t and equal to or less than the interval W2, heat can be efficiently diffused over the whole surface of the lower frame 3. That is, when the width W1 of the leg portion 10 of the printed circuit board 5 is set to a value equal to or more than the interval W2 of the LED light sources 13, as shown in FIG. 6, a diffusion path of heat is interrupted by the large hole portion and hence, the heat radiation effect is hardly obtainable. Here, although the heat radiation effect is increased when the width W1 of the leg portion 10 is set as narrow as possible, a function of the leg portion 10 of fixing and supporting the printed circuit board 5 is lost and hence, it is necessary to ensure at least a width which is equal to or more than the plate thickness t of the printed circuit board 5. Here, although it is necessary to ensure the plate thickness t or more as the width W1 of the leg portion 10, in a prototype which is actually made as below, there may be the case that the width of the leg portion is slightly smaller than the plate thickness.

According to the present invention, it is found out that when the plate thickness of the printed circuit board 5 is set to 0.8 mm, the interval of the LED light sources 13 which are mounted on the printed circuit board 5 is set to 16.0 mm, and the width of the leg portion 10 of the printed circuit board 5 is set to 0.7 mm or more and 3.0 mm or less, heat can be radiated most efficiently. It is also found that when the width of the leg portion 10 of the printed circuit board 5 is set to 0.7 mm or more and 5.0 mm or less under the same condition, the efficient heat radiation can be achieved. Further, even when the width of the leg portion 10 of the printed circuit board 5 is set to 0.7 mm or more and 16.0 mm or less under the same condition, it is possible to obtain an allowable heat radiation effect.

In this case, it is preferable to set the number of leg portions 10 formed on the printed circuit board 5 to 4 or 5 with respect to the printed circuit board 5 having a size of 5 inch to 10 inch. This is because that not to mention the causal relationship with heat radiation, the leg portions 10 formed on the printed circuit board 5 have a function of preventing warping of the printed circuit board 5 and hence, when the number of the leg portions 10 is small, the warping preventing function is decreased, while when the number of the leg portions 10 is increased, although the warping preventing function is enhanced, the heat radiation effect is lowered whereby such number is optimum. Here, provided that the number of leg portions 10 formed on the printed circuit board 5 falls within a range from 2 to 10, it is possible to obtain the desired advantageous effect. However, when the number of leg portions 10 formed on the printed circuit board 5 is increased further with respect to the printed circuit board 5 having the size of 5 inch to 10 inch, the number of hole portions 11 formed in the lower frame 3 is increased thus decreasing the heat radiation effect.

Next, the layer structure of the printed circuit board 5 according to the present invention is explained in conjunction with FIG. 8.

As shown in FIG. 8, the printed circuit board 5 of the present invention which mounts the LED light sources 13 thereon is a board which uses the plate-like metal layer 15 as the base, and forms the first insulation layer 16, the conductive layer 17 and the second insulation layer 18 on the base. The printed circuit board 5 of the present invention which adopts the base made of metal implies the board which uses at least plate-like metal layer 15 as the base. Such a board exhibits the favorable thermal conductivity compared to the printed circuit board which uses the base made of glass epoxy or polyimide and hence, it is possible to expect an advantageous effect that the heat is efficiently transmitted to the lower frame.

The present invention can be used in the field of the liquid crystal display device and the backlight device.

1. A liquid crystal display device comprising a liquid crystal panel and a backlight device arranged on a back surface of the liquid crystal panel, wherein
the backlight device includes a light guide plate, a printed circuit board which mounts an LED light source which is arranged to face a side surface of the light guide plate thereon and forms a leg portion thereon, and a metal-made lower frame member which is positioned on a surface of the printed circuit board opposite to a side on which a leg portion of the printed circuit board and the LED light source are mounted, wherein
the printed circuit board is a board which adopts a metal member as a base,
the lower frame member includes a hole portion into which a leg portion of the printed circuit board is inserted, and
the printed circuit board has the leg portion thereof inserted into the hole portion of the lower frame member, and
has a surface thereof on a side opposite to a side on which the LED light source is mounted fixed to the lower frame member by a pressure sensitive adhesive double-coated tape.

2. A liquid crystal display device according to claim 1, wherein the pressure sensitive adhesive double-coated tape is a thermally conductive pressure sensitive adhesive double-coated tape having the thermal conductivity of 0.2 W/m·k or more.

3. A liquid crystal display device according to claim 1, wherein the liquid crystal display device includes an upper frame member which is arranged above the lower frame and the light guide plate, and a projecting portion is formed on the upper frame member corresponding to a position where the printed circuit board is arranged, and the printed circuit board is arranged between the projecting portion and the lower frame.

4. A liquid crystal display device according to claim 1, wherein the number of leg portions formed on the lower frame member is within a range from 2 to 5.

5. A liquid crystal display device according to claim 1, wherein 2 or more LED light sources are mounted on the printed circuit board.

6. A liquid crystal display device according to claim 5, wherein assuming a thickness of the printed circuit board as t, a width of the leg portion of the lower frame member as W1, and an arrangement interval of the LED light sources as W2, the width W1 is set equal to or more than the thickness t and equal to or less than the arrangement interval W2.

7. A liquid crystal display device according to claim 5, wherein a width of the leg portions of the lower frame member is set to 0.7 mm or more and 16.0 mm or less.

8. A liquid crystal display device according to claim 7, wherein a width of the leg portions of the lower frame member is set to 0.7 mm or more and 5.0 mm or less.

9. A liquid crystal display device according to claim 8, wherein a width of the leg portions of the lower frame member is set to 0.7 mm or more and 3.0 mm or less.

10. A liquid crystal display device according to claim 1, wherein the printed circuit board which forms a base thereof from plate-like metal and on which a first insulation layer, a conductive layer and a second insulation layer are formed on the base.

11. A liquid crystal display device comprising a liquid crystal panel and a backlight device which is arranged on a back surface of the liquid crystal panel, wherein
the backlight device includes
a light guide plate,
a printed circuit board which mounts two or more LED light sources which are arranged in the direction toward a side surface of the light guide plate thereon and includes 2 or more and 5 or less leg portions having a width of 0.7 mm or more and 16.0 mm or less, and
metal-made lower frame member which is integrally formed at a position which faces a side of the printed circuit board opposite to a side on which a leg portion of the printed circuit board and the LED light source are mounted,
the printed circuit board is a board which adopts a metal member as a base,
the lower frame member includes a hole portion corresponding to a position of the leg portion formed on the printed circuit board, and
the printed circuit board has the leg portion thereof inserted into the hole portion of the lower frame member and has a surface thereof on a side opposite to a side on which the LED light source is mounted fixed to the lower frame member by a pressure sensitive adhesive double-coated tape.

12. A liquid crystal display device according to claim 11, wherein the pressure sensitive adhesive double-coated tape is a thermally conductive pressure sensitive adhesive double-coated tape having the thermal conductivity of 0.2 W/m·k or more.

13. A liquid crystal display device according to claim 11, wherein the liquid crystal display device includes an upper frame member which is arranged above the lower frame and the light guide plate, and a projecting portion is formed on the upper frame member corresponding to a position where the printed circuit board is arranged, and the printed circuit board is arranged between the projecting portion and the lower frame.

14. A liquid crystal display device according to claim 11, wherein a width of the leg portions of the lower frame member is set to 0.7 mm or more and 5.0 mm or less.

15. A liquid crystal display device according to claim 11, wherein a width of the leg portions of the lower frame member is set to 0.7 mm or more and 3.0 mm or less.

16. A liquid crystal display device according to claim 11, wherein the printed circuit board which forms a base thereof from plate-like metal and on which a first insulation layer, a conductive layer and a second insulation layer are formed on the base.

17. A liquid crystal display device according to claim 16, wherein the liquid crystal display device includes an upper frame member which is arranged above the lower frame and the light guide plate, and a projecting portion is formed on the upper frame member corresponding to a position where the printed circuit board is arranged, and the printed circuit board is arranged between the projecting portion and the lower frame.

18. A liquid crystal display device according to claim 16, wherein assuming a thickness of the printed circuit board as t, a width of the leg portion of the lower frame member as W1, and an arrangement interval of the LED light sources as W2, the width W1 is set equal to or more than the thickness t and equal to or less than the arrangement interval W2.

19. A backlight device comprising a light guide plate, a printed circuit board which mounts an LED light source which is arranged to face a side surface of the light guide plate thereon and has a leg portion, and a metal-made lower frame member which is positioned on a surface of the printed circuit board opposite to a side on which a leg portion of the printed circuit board and the LED light source are mounted, wherein
the printed circuit board is a board which adopts a metal member as a base,
the lower frame member includes a hole portion into which a leg portion of the printed circuit board is inserted, and
the printed circuit board has the leg portion thereof inserted into the hole portion of the lower frame member, and has a surface thereof on a side opposite to a side on which the LED light source is mounted fixed to the lower frame member by a pressure sensitive adhesive double-coated tape.

20. A backlight device according to claim 19, wherein the pressure sensitive adhesive double-coated tape is a thermally conductive pressure sensitive adhesive double-coated tape having the thermal conductivity of 0.2 W/m·k or more.
